(19) United States
(12) Patent Application Publication
(10) Pub. No.: US 2017/0091889 A1
(43) Pub. Date: Mar. 30, 2017

(54) FLEXIBLE DESTINATION SETTING AND ROUTE INDICATION SYSTEM

(71) Applicant: Detong Chen, Grand Forks, ND (US)

(72) Inventor: Detong Chen, Grand Forks, ND (US)

(21) Appl. No.: 14/865,281

(22) Filed: Sep. 25, 2015

(51) Int. Cl. G06Q 50/26; H04W 84/18

(52) U.S. Cl. CPC G06Q 50/265; H04W 84/18

(57) ABSTRACT

A flexible destination setting and route indication system which can detect many different types of emergencies, and which allows for the rapid development of a large number of low-cost device nodes running with wireless communications. The preferred embodiment of the system shall eliminate the dependence on a central host computer. Primary functions include detection of a disaster or other emergency, the intelligent calculation of routes that will help those in a building other disaster location find an exit or emergency equipment, and real-time communication of safe routes to victims and emergency personnel.

### CROSS REFERENCE TO RELATED APPLICATIONS

Not applicable.

### FIELD OF INVENTION

This invention relates to an emergency evacuation and rescue system, and specifically to a system used for indicating a safe route out of a building or other appropriate location in an emergency situation.

### BACKGROUND

In an emergency situation, such as a fire or earthquake, it can be difficult for panicking people to find routes to safety or rescue workers to find survivors. There are products in the prior art that attempt to route individuals along safe routes, but these existing systems have many shortcomings, including:
Each device node detecting the disaster or emergency is connected to a host computer by point-to-point wiring. If the host computer is damaged or the point-to-point connections fails, a system failure will likely occur.
The deployment of a large number of device nodes is relatively expensive due to the large number of wires connecting the nodes to each other and to the host computer. This limits the scalability of the system.
Even if the connections between nodes in existing are wireless, there still will be many issues, including high module cost due to higher power consumption, the emission of larger amounts of electromagnetic radiation, and the handling of channel congestion problems. Architects always need to consider the entire distribution of device nodes in the initial design of the area, otherwise post-installation and extension will become very inconvenient.
So-called “intelligent” emergency alarm and evacuation systems in the market are rudimentary. Currently, the only type of this system is the fire alarm and evacuation system. However, emergency situations include far more than just fire, including flood, earthquake, building/structure collapse, explosion, gas leak, etc.
Existing systems do not do a good job of indicating evacuation routes. Humans trapped in such a situation cannot easily find an available escape route.
Existing systems cannot tell people about adjacent resources which they can effectively utilize, such as water, fire extinguishers, lifeboats, and even safe areas where disaster has not yet spread.
Existing systems do not allow for cooperative rescue, where the respective locations of rescue personnel and survivors may be shared with the system and communicated to the other party.

What is needed in the art is an emergency evacuation system which overcomes these disadvantages with the ability to indicate safe evacuation routes, as well as other types of routes, based on real-time sensor information and to drastically reduce system failure by creating a decentralized system.

### SUMMARY OF THE INVENTION

According to one aspect of the present invention, a flexible destination setting and route indication system is described which can detect many different types of emergencies, and which allows for the rapid development of a large number of low-cost device nodes running with wireless communications. The preferred embodiment of the system shall have four primary functions, in order to eliminate the dependence on a central host computer. These primary functions include:
In the case of a non-emergency, automatically checking node status without involving the host computer.
Detecting an emergency situation without involvement of the host computer and quickly determining routes to safe locations, giving a clear indication of routes through a number of means.
People and device nodes have the right to set the different type of destination for different purpose. Such as a trapped person can set the nearest device node which her/his device connects via wireless as the destination called “the location of trapped people” for help, a rescuer can set the nearest device node which her/his device connects via wireless as the destination called “the location of rescuer” for better cooperating, the administrator can set the destination called “exit” and “the location of useful resource” for higher survival rate. The device node can set the destination called “Safe place” for letting people easily find safe place to take refuge.
After fully extinguishing the disaster, administrator can reset the device nodes, let them return to normal operating mode (no emergency happens status).

These aspects and others are achieved by the present invention, which is described in detail in the following specification and accompanying drawings which form a part hereof.

### BRIEF DESCRIPTION OF DRAWINGS

FIG. 1 shows one possible arrangement of nodes in the system of the present invention.

FIG. 2 provides an illustration of how the nodes of the present invention may be set up in a physical location.

FIG. 3 shows an example terminal software screen, used for configuring the nodes in the system of the present invention.

FIG. 4 is an illustration of one embodiment of a device node in the system of the present invention.

FIG. 5 is an illustration of one embodiment of a route indication device, in the form of a cylindrical arrangement of LEDs.

FIG. 6 is an illustration showing one possible arrangement of components in the system of the present invention and how they might be placed in a typical room or hallway.

FIG. 7 is a functional block diagram of one embodiment of a network node from the system of the present invention.

FIG. 8 shows a map of one possible arrangement of network nodes in a building.

FIG. 9A illustrates the actual communication routes between the network nodes of the arrangement of nodes shown in FIG. 8, as they would appear in an ad hoc network.

FIG. 9B illustrates the communication routes between the network nodes of the arrangement of nodes shown in FIG. 8, as they would appear when using a geographical neighbor's scheme.

FIG. 10 illustrates how network nodes communicating with neighbor nodes can determine and report exceptions.

FIG. 11 is an illustration of how route generation can occur in one embodiment of the system of the present invention.

FIG. 12 is a flowchart capturing one embodiment of an algorithm that may be used with the system of the present invention.

FIG. 13 is an illustration of one embodiment of a user device interface screen showing safe evacuation routes.

FIG. 14 is an illustration of how the orientation of the evacuation route screen of FIG. 13 can be changed such the directions indicated on the device match those in the real building.

FIG. 15 shows a flowchart capturing one embodiment of an algorithm that may be executed on a portable device in the system of the present invention.

### DETAILED DESCRIPTION OF THE PREFERRED EMBODIMENT

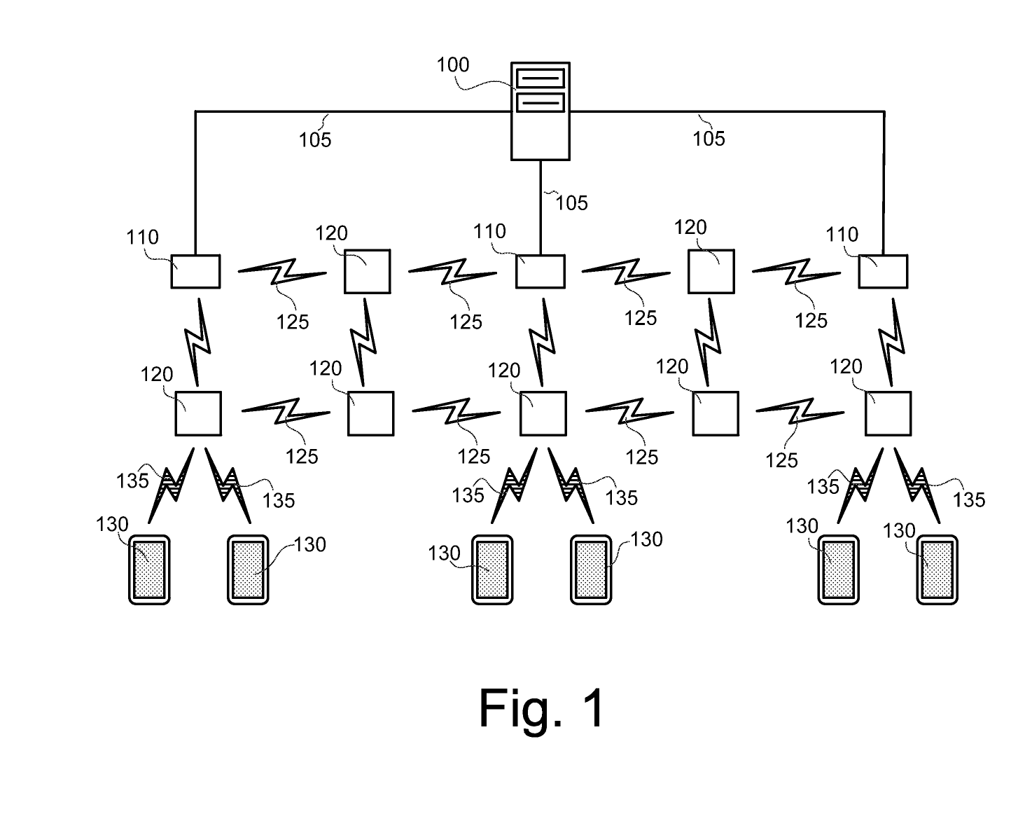

With reference now to the drawings, and in particular to FIGS. 1 through 15 thereof, a new flexible destination setting and route indication system and method of use will be described.

References in the specification to “one embodiment”, “an embodiment”, “an example”, “another embodiment”, “a further embodiment”, “another further embodiment,” and the like, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one of ordinary skill in the art to affect such feature, structure, or characteristic in connection with other embodiments whether or not explicitly described.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

The flexible destination setting and route indication system of the present invention consists of four major components:
A host computer, including specialized terminal control software.
One or more wireless device nodes, including specialized device node software.
Peripheral equipment, including in one embodiment, but not limited to, a speaker for broadcasting instructions and a multi-directional visual route indicating device.
One or more mobile electronic devices (or simply “mobile device”), such as cell phones, tablet computers, and other portable devices. Specialized application software will be downloaded to each mobile device that is to participate in the flexible destination setting and route indication system.

The key to the success of the flexible destination setting and route indication system (hereinafter “route indication system”) of the present invention is the arrangement of the nodes in a wireless, ad-hoc network. The characteristics of an ad-hoc network are as follows:
Each device node can communicate with every other device node in the network using a peer-to-peer (P2P) connection, where any node can initiate a communication session with any other node in the network.
Each device node can broadcast to all other nodes at once.

There are several wireless communication technologies which can be used to create wireless communication between device nodes. Some of these technologies available today include Wi-Fi, Bluetooth, and ZigBee, but any other appropriate wireless technology can be used to connect the device nodes in the ad-hoc network. Some wireless technologies will work better than others depending on the application and the size of the size of the network. For example, if the device nodes communicate frequently and heavily, ZigBee may not be ideal due to its low ratio speed.

There are also various technologies which can meet the requirements of wireless communication between the device nodes and the mobile device, including Wi-Fi and Bluetooth. Although ZigBee could satisfy this requirement, phones easily seen in the market today are generally not equipped with ZigBee. However, ZigBee or any other appropriate wireless technology could be used without deviating from the intent of the present invention.

For practical purposes, there are six likely arrangements based on technologies available today, at the time of the writing of this specification. The following information is an example only and is not meant to be limiting in any way:
Device nodes communicate with each other via Wi-Fi, Device nodes talk to mobile devices via Wi-Fi.
Device nodes communicate with each other via Bluetooth, Device nodes talk to mobile devices via Bluetooth.
Device nodes communicate with each other via ZigBee, Device nodes talk to mobile devices via Wi-Fi.
Device nodes communicate with each other via ZigBee, Device nodes talk to mobile devices via Bluetooth.
Device nodes communicate with each other via Bluetooth, Device nodes talk to mobile devices via Wi-Fi.
Device nodes communicate with each other via Wi-Fi, Device nodes talk to mobile devices via Bluetooth.

The arrangement of this route indication system: To create the route indication system, a sufficient number of device nodes are installed to adequately cover the area defined to be protected. After the nodes are installed and provided with adequate power to perform, the wireless communication module for each device node is configured (that is, set to an appropriate transmitting power, set to communicate as part of the ad-hoc network, etc.) Because of the characteristics of an ad-hoc network, the device nodes will form a distributed network automatically, and any new nodes introduced to the network will be added automatically.

At least one device node will be connected to the host computer by a direct wired connection. This device node will serve as a terminal device node (the host computer communicates with this terminal device node directly via the wired connection). There may be more than one terminal device node.

Once the device nodes are thus installed, an operator opens the terminal software on the host computer and configures parameters for each device node depending on the node's location, geographic relationship, communication address, and the communication address of the appropriate terminal network node. Subsequently, the software running on the host computer will send all configuration parameters for all the nodes to all of the terminal device nodes, all the terminal devices node will route specific configuration parameters to the related device node via peer-to-peer (P2P) connection. Each device node (including the terminal device nodes) receiving the specific parameters will process the parameters and a success message will be sent back to the terminal device node. The terminal device node will route all the messages which come from any device node to the host computer.

In order to relieve wireless communication congestion, multiple terminal device nodes could be provided at different points in the network to help relieve communication congestion.

Once each device node's configuration is completed, the network is operation in the normal operating mode. In normal operating mode in the present invention, each device node exchanges data only with other device nodes which are configured to be geographical neighbors and the terminal device node. A device node is typically configured to be a “geographical neighbor” to another device based on its physical location in relation to that device node, as well as its physical location in the building or structure being protected by the route indication system. This definition of neighbors will be explained in additional detail later in this specification.

Each device node will be equipped with sensors appropriate for detecting an emergency. For example, a device node may be equipped with heat and smoke sensors in a system designed to detect building fires.

Turning now to FIG. 1, we see one possible arrangement of nodes in the system of the present invention. A host computer 100 is attached to the network and used for initial configuration of the network, but is thereafter not needed for the operation of the network during normal operation. The network itself consists of terminal network nodes 110 and non-terminal nodes 120. A network node comprises a device node capable of wireless communications 125 and peripheral equipment (such as smoke alarms, route indication lights, audio speakers, etc.)

A terminal network node 110 is a network node that is connected directly to the host computer 100 via a hard-wired connection 105.

A non-terminal network node 120 is a network node that does not have a direct hard-wired connection to the host computer 100.

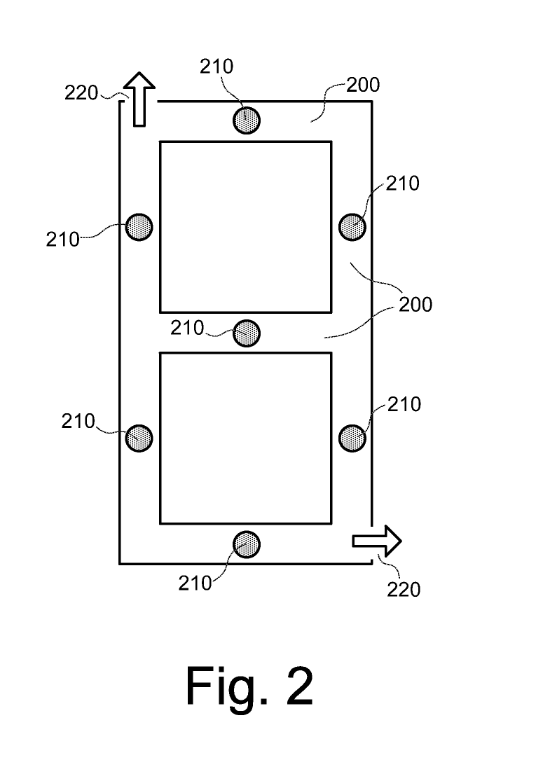

Beginning in FIG. 2, the reference designator 210 will be used to refer generically and collectively to both terminal network nodes 110 and non-terminal network nodes 120.

The network of the present invention comprises both terminal network nodes 110 and non-terminal network nodes 120, all of which are connected via a wireless communications protocol 125 as previously described. Each node in the network is capable of communicating via a wireless protocol 135 to any number of portable electronic devices 130.

The wireless protocol 125 used between network nodes may or may not be a different protocol than the wireless protocol 135 between a network node 110/120 and a user's portable electronic device 130. In one embodiment, wireless protocol 125 may be ZigBee communication, and wireless protocol 135 may be Bluetooth communication. In another embodiments, both wireless protocols 125 and 135 may be Bluetooth communication. However, any appropriate wireless communications protocol or standard may be used for either or both wireless protocols 125 and 135.

The host computer 100 will satisfy the following requirements:
It must connect to at least one network node (terminal network node 110) via a hard-wired connection 105.
It must be able to notify an external emergency response system, such as the local police station or fire department, when an emergency occurs.
It must execute the terminal software.

The software running on the host computer 100, that is, the terminal software, will satisfy the following requirements:
The terminal software must allow an administrator to set the geographic position of each network node 110/120.
The terminal software must allow an administrator to identify whether a network node 110/120 is associated with an exit.
The terminal software must allow an administrator to identify whether a network node 110/120 is directly wired with the host computer (that is, whether or not the node is a terminal network node).
The terminal software must allow an administrator define the relationships between each network node 110/120 and the other network nodes 110/120 in the system. The administrator can define whether two nodes are geographic neighbors or not (physically adjacent in the real world based on the structure of the building they are mounted in) as well store the distances between nodes in the network.
The terminal software must allow an administrator to generate a distribution map for verifying the configuration of geographical neighbors.
The terminal software must allow a terminal network node 110 to send parameter information including the communication address of its neighbors in the ad-hoc network and the address of the terminal network node 110 from the host computer 100 to related network node 110/120 via the aforementioned ad-hoc distribution network.
Once properly configured, the terminal software will run in normal operation mode. Also, the terminal software can receive data, via a terminal network node 110, including data collected by all network nodes 110/120, including sensor readings, status information, etc., as well as information from the users' portable electronic devices 130, such as the device ID or position based on closest network node 110/120 to user.

FIG. 2 provides an illustration of how the network of the present invention may be set up in a physical location. For this discussion, it should be remembered that the reference designator 210 will be use to refer generically and collectively to both terminal network nodes 110 and non-terminal network nodes 120.

Network nodes 210 are mounted in appropriate locations in a building or structure, typically attached to a ceiling or high on a wall or a combination of both. The nodes 210 are typically located along hallways 200 or other paths that could be used as escape routes in an emergency, or throughout a large open area such as a warehouse. The purpose of the network nodes 210 is to guide users safely to a building exit 220, or to another location, which may include the location of supplies (such as first aid, food, water, etc.), emergency shelter areas, or the location of emergency equipment.

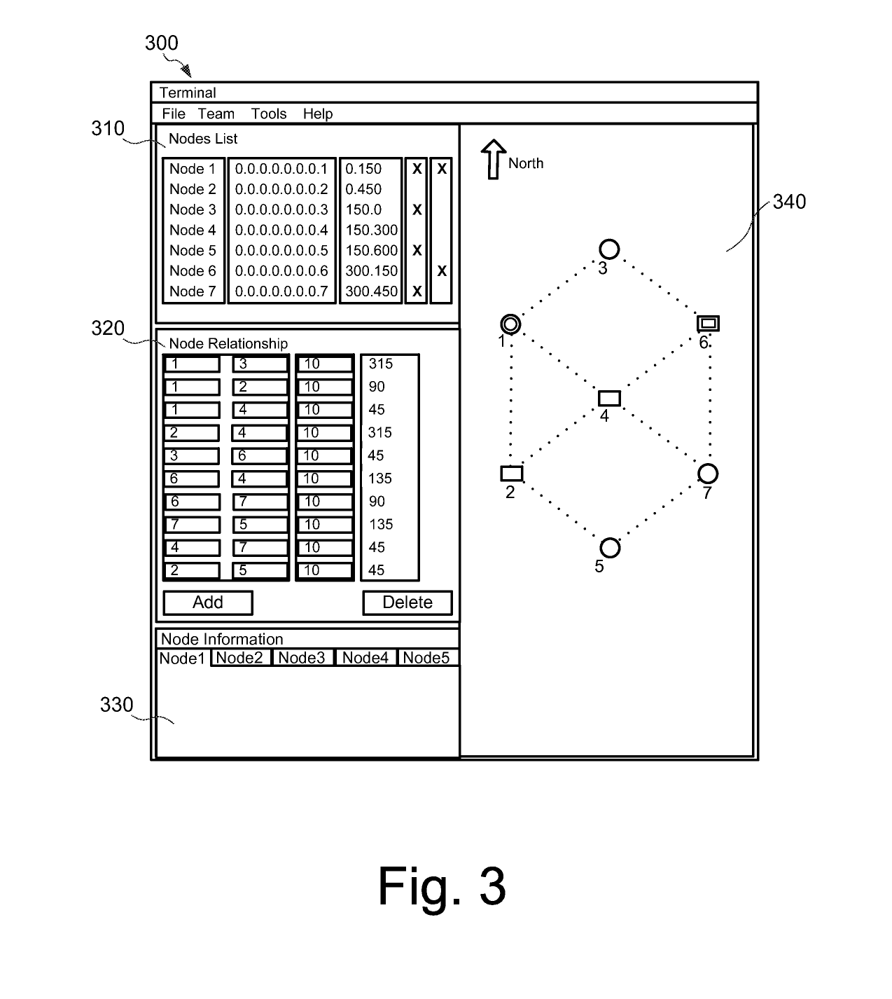

FIG. 3 shows an example terminal software screen 300, used for configuring the nodes in the system of the present invention. In this embodiment, the terminal software screen 300 contains a nodes list 310, a node relationship block 320, a node information block 330, and a configuration diagram block 340.

The nodes list 310 is an area where the operator can define information for each network node 210, including, but not limited to, a unique address for each node 210, a physical location for each node 210, an indication if the node 210 is associated with an exit, and whether the node 210 is a terminal node.

The node relationship block 320 allows the operator define the relationship between the nodes 210 in the network, including, but not limited to, whether or not they are geographical neighbors, entering the physical distance between nodes 210, and the angular position of each node 210 to other nodes 210 will be automatically calculated based on the physical location for each node. Two nodes are geographical neighbors if a person can walk from one node to the other without passing other nodes.

The node information block 330 on the terminal software screen 300 displays the collected data gathered from each network node 210 in the network as seen by a terminal device node.

The configuration diagram block 340 displays the configuration graphically for the operator, such that they can verify the configuration of geographical neighbors they are performing. The configuration diagram block 340 is essentially a map, and the graphical symbol used to represent each network node 210 delivers additional information on each node 210. For example, in the example embodiment shown here, a circle means the node is related to an exit, and a circle within a circle means this node 210 is a terminal node 110. Dotted lines are shown in this example to show which nodes 210 are defined as geographic neighbors.

A network node 210 as defined herein has three main responsibilities:
To exchange data and messages with its defined geographical neighbors, for the purposes of route calculation and neighbor health monitoring.
The real-time sensing/monitoring of potential disasters.
Communication with users' portable electronic devices that are part of the network.

A network node 210 is defined in one embodiment as having a wireless communications module, at least one sensor for detecting disaster, a route indication device, and an external loudspeaker for broadcasting alarms and instructions to individuals in the disaster.

Each network node 210 is installed at a location such that it can readily detect an emergency situation as well as provide an indication of a route to safety or supplies. Each network node 210 is defined such that it can only communicate with its defined geographical neighbors (other network nodes 210) and at least one associated terminal network node 110 (which may or may not be a geographical neighbor.)

In standard operation (non-emergency), a network node 210 can automatically check geographical neighbors without the involvement of the host computer, and can inform the host computer 100 of the faulty node, assuming the host computer 100 is still capable of receiving information.

When an emergency is detected, each network node 210 can run independently without the host computer, allowing the network to be operational even when some of the nodes may be destroyed. Because the network nodes rely on short distance communication, the network nodes 210 in such a network benefit from lower cost, lower power consumption, fewer wireless communication issues, and better communication quality.

During an emergency situation, users of the present invention can use their portable electronic devices 130 to have the route indication system provide them different types of route information. For example, a rescue worker using the system can use their portable electronic device 130 to label their portable electronic device 130 as a “rescue worker”, so that people trapped in an emergency situation can quickly find help. Conversely, a person trapped in building can set the node nearest them as “location of trapped person” or set their portable device 130 to signal “person in need of help”, allowing other uses of the system to locate them quickly.

A person trapped in the emergency situation can use their portable electronic device 130 to select an appropriate route or destination. The possible routes or destinations may include, but are not limited to:
Nearest safe exit
Location of emergency equipment
Shelter
Location of rescue worker

The network can then automatically calculate the routes to the above destinations, and indicate the routes through a specially designed route indication device and a loudspeaker, sending route information to the user's portable electronic device for display.

After the emergency situation is over, an administrator can reset the device nodes using the terminal software, allowing them return to normal operating mode (no emergency).

Any type of sensor may be built into the network nodes 210, or any combination of sensors. These sensors may include, but not be limited to, a smoke sensor, temperature sensor, carbon monoxide sensor, water sensor, vibration sensor, motion sensor, facial recognition device, or any other appropriate type of sensor.

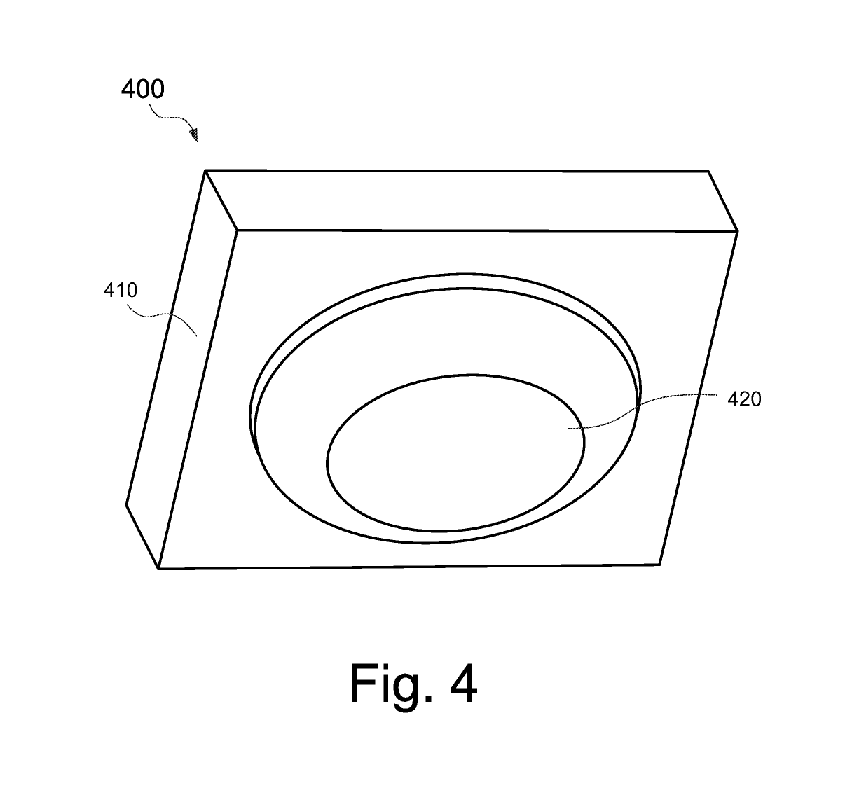

Turning now to FIGS. 4 through 6, we see one embodiment of a typical network node 210. FIG. 4 is an illustration of one embodiment of a device node 400 in the system of the present invention. The device node 400 is comprised of a wireless communication module 410, responsible for routing messages along the wireless ad-hoc communications network of the present invention. Device node 400 may also comprise one or more sensors 420, such as the types of sensors described above.

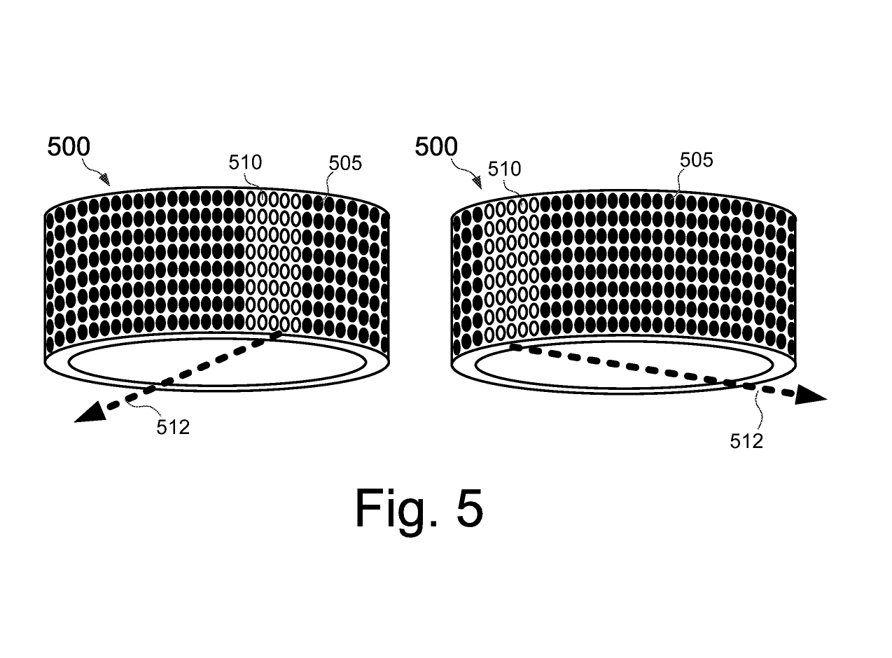

FIG. 5 is an illustration of one embodiment of a route indication device 500, in the form of a cylindrical arrangement of light emitting diodes 505, or LEDs. In the embodiment shown here, LEDs 505 cover the outside of a cylindrical or hemispherical route indication device 500. When an emergency occurs, a certain section of LEDs 510 (perhaps shaped like a band of lit LEDs 510 as shown in the two example devices 500 shown in FIG. 5) light up to indicate the direction of a safe route or destination.

A user trapped in a building can look up at one of these route indication devices 500 and look for the band of lit LEDs 510 around the otherwise darkened cylinder. The route indication device will receive information from the network node 210 with which it is associated, and will change the displayed band of lit LEDs 510 to indicate a safe route. If a user were to draw an imaginary line through the band of lit LEDs 510 on the side of the cylinder such that it extends through the center of the cylinder, such as the dashed arrows 512 in FIG. 5, that line would show the safe route indicated by the system.

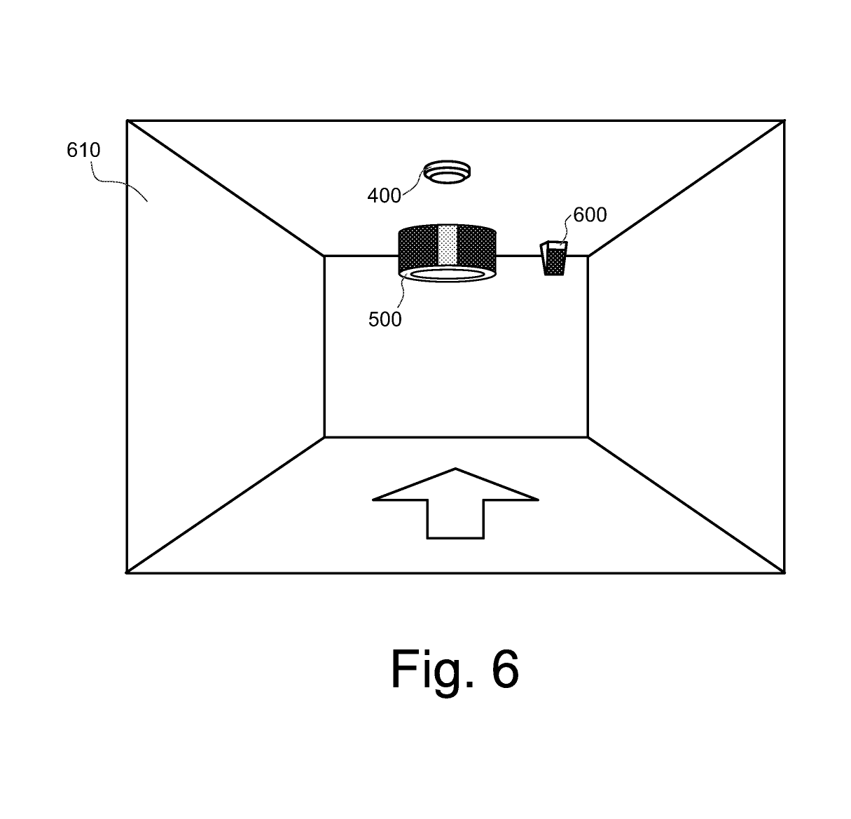

FIG. 6 is an illustration showing one possible arrangement of components in the system of the present invention and how they might be placed in a typical room or hallway 610. The device 400 may be mounted on a ceiling or high on a wall where it can have a “view” of any potential emergency or disaster situation.

Mounted near the device node 400, a route indication device 500 and a loudspeaker or public address system 600 would be commanded by the device node 400 to indicate the safe route (by moving the band of lit LEDs on the route indication device 500 or by transmitting safety instructions or commands over the loudspeaker 600). The large arrow shown on the floor of the room 610 in FIG. 6 is provided for reference only, indicating the direction of travel for anyone seeking safety.

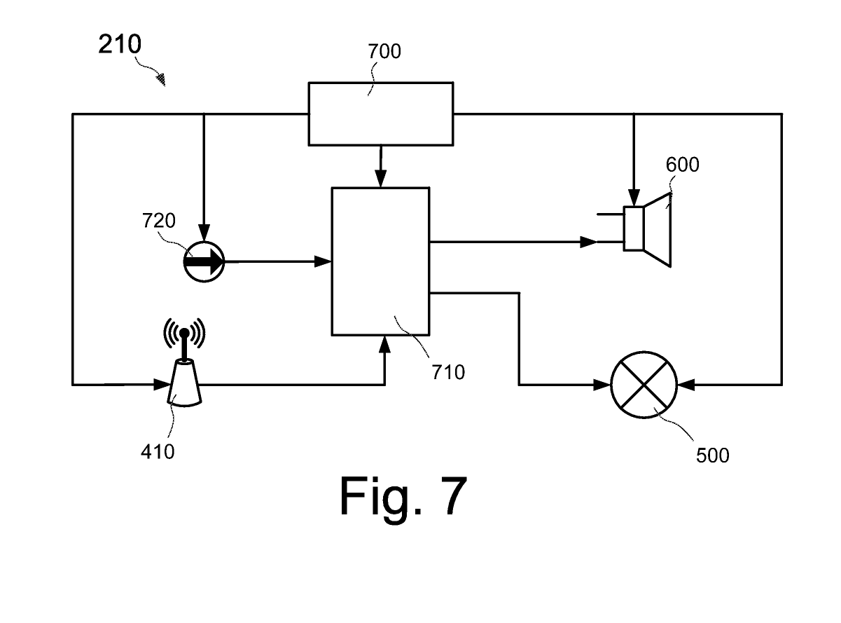

FIG. 7 is a functional block diagram of one embodiment of a typical network node from the system of the present invention. In one embodiment, the network node 210 comprises a power supply 700, a microprocessor 710, one or more sensors 720, a wireless communications module 410, a loudspeaker 600, and a route indication device 500.

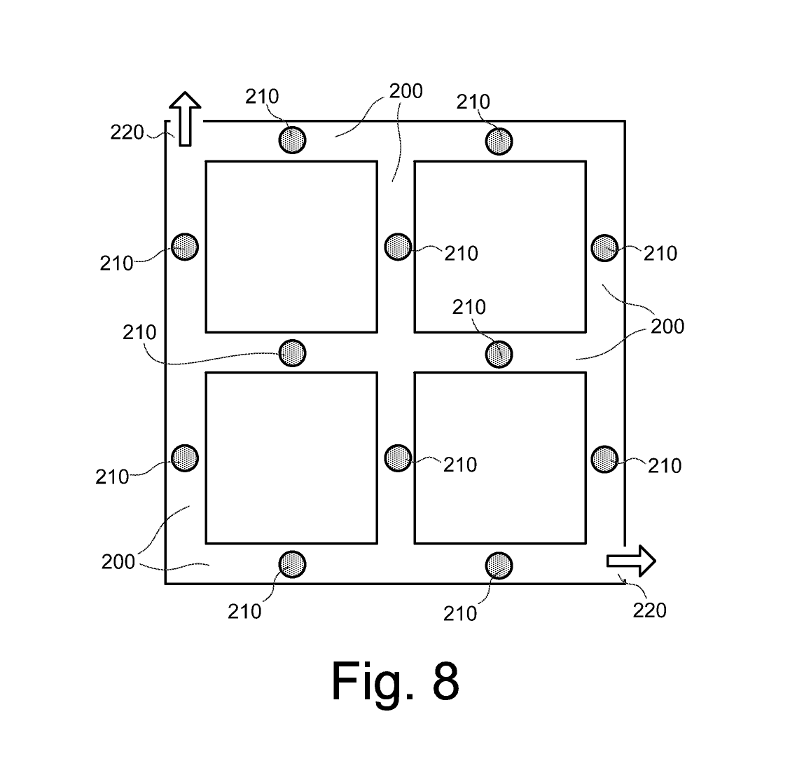

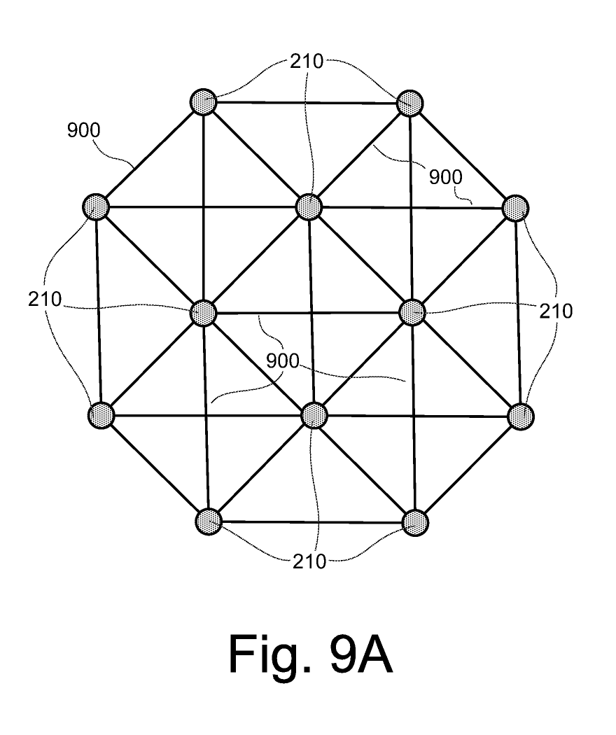

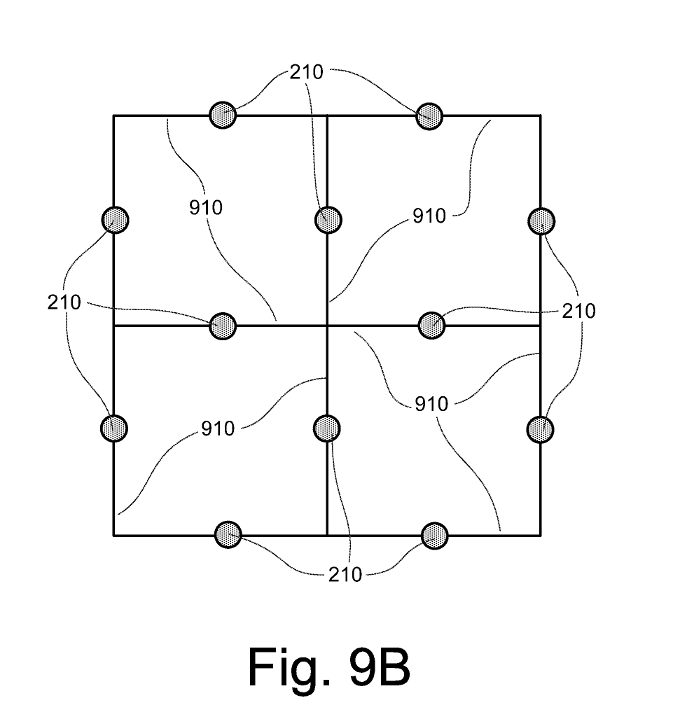

FIG. 8 shows a map of one possible arrangement of network nodes in a building. The lines in the figure represent the walls of a building, creating routes or hallways 200, leading eventually to exits 220. Network nodes 210 are mounted around the building, such as in the hallways 200 or in larger rooms like warehouses. FIGS. 9A and 9B will reference the example arrangement of physical nodes shown in FIG. 8.

FIG. 9A illustrates the actual communication routes between the network nodes 210 of the arrangement of nodes shown in FIG. 8, as they would appear in an ad hoc network. As previously discussed, the network nodes 210 are arranged in an ad hoc network configuration as far as communications goes. In an ad hoc network, every network node 210 can talk with any other network node 210 via wireless communication pathways 900. The arrangement of network nodes 210 in FIG. 9A shows that each network node 210 is communicating with a number of other network nodes 210, representing those within wireless communications distance. Any given node 210 can communicate with any other that is out or wireless range by routing messages through a closer node 210. It is also possible that all of the nodes 210 in the network are able to directly communicate with each other, if the network is physically small enough for wireless, peer-to-peer communications from one node 210 to another.

FIG. 9B illustrates the communication routes between the network nodes of the arrangement of nodes shown in FIG. 8, as they would appear when using a geographical neighbors scheme. It is important to recognize that the network of FIG. 9B is the exact same network of FIG. 9A, but only the administrator-defined communication paths 910 are shown in FIG. 9B. These defined paths 910 are those paths with map to the physical structure of the building as shown in FIG. 8. Remember, the definition of geographical neighbors is any two nodes 210 where a person can walk from one to the other without passing through other nodes 210. The administrator must define these paths 910 using the terminal software.

Each network node 210 will regularly receive periodic messages from its geographic neighbor nodes as a means of checking on the health of the system. If the periodic message is not received from a neighbor network node 210 within a administrator-defined period of time, the sending node 210 will send a message to a terminal device node 110, reporting the error of that neighbor node 210. Once the sending node 210 begins to again receive periodic messages from the neighbor node 210 again, the sending node 210 will send another message to the terminal device node 110, reporting the recovery of the once faulty neighbor node 210.

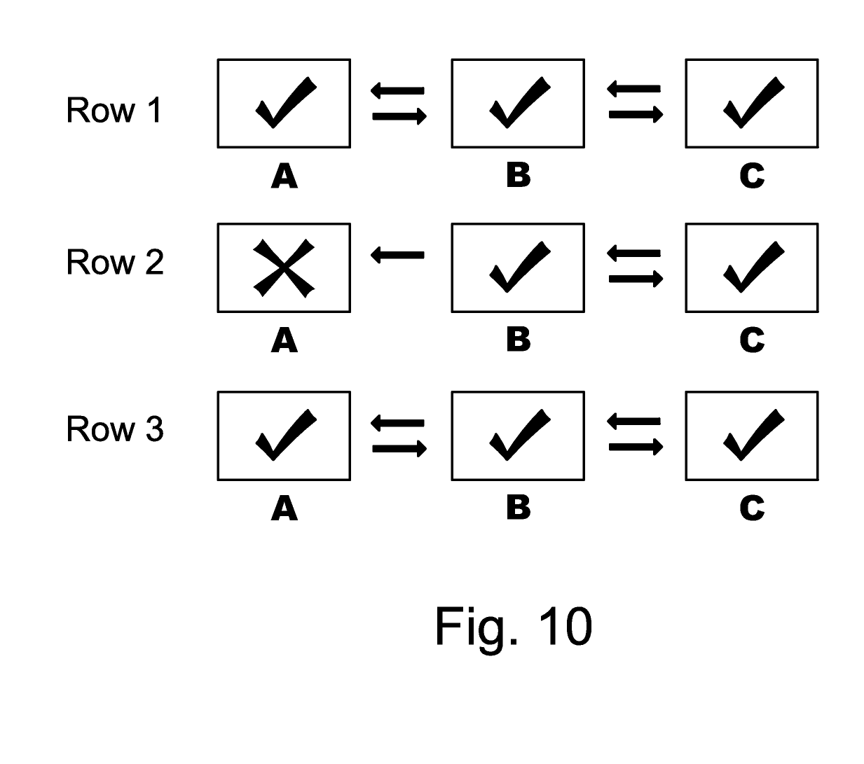

FIG. 10 illustrates how network nodes 210 communicating with neighbor nodes 210 can determine and report exceptions in those neighbor nodes 210. Each of Rows 1 through 3 in FIG. 10 represent a different moment in time for each of three neighbor nodes A, B, and C. At Row 1, we see a healthy network, with all nodes both sending and receiving periodic status messages from each other. At the time shown in Row 2, node A has gone silent for some reason, and is no longer sending the periodic messages to node B. Node B, in this situation, would send information to a terminal node 110 that node A is currently offline, possibly routing this information through node C, which is still working in Row 2. Finally, in Row 3, node A is sending messages again, and node B can communicate with a terminal node 110 that the system is working again.

Using the communication scheme introduced in FIG. 10, where nodes communicate periodically with only geographic neighbor nodes, the route indication system can determine safe routes and communicate this information to a user's portable electronic device.

Routes Generation Mechanism:

When an emergency occurs, a network node 210 calculates the routes to all the destinations automatically. In one embodiment of the present invention, there are 6 kinds of destinations and 11 types of routes, identified as follows:

6 Destinations Types:

The six destination types in this embodiment are:
Exit: Only a rescue worker's portable electronic device and the host computer (controlled by an administrator) have permission to set the location of exits.
Rescue Worker Location: Only a rescue worker's portable electronic device has permission to set the location of the rescue worker.
Trapped People's Location: Only users' and rescue workers' portable electronic devices have permission to set the location of people in need of help.
Safe Location (locations where disaster has not spread yet): Only network nodes have the permission to set the Safe Location condition, when the sensor does not detect an emergency, the network node will automatically set this variable.
Locations of Resources: These are locations with available resources, such as fire extinguishers, water, first aid supplies, etc. Only the host computer, controlled by an administrator, can set this value.
Unsafe Location (location where disaster has spread): Only network nodes have the permission to set the Unsafe Location condition, when the sensor detects an emergency, the network node will automatically set this variable.

11 Route Types:

The first five six types of destinations defined above can be reached using one of two different route strategies that can be selected by the user using their portable electronic device. One route strategy or route type is “hazard avoidance”, giving preference to routes that go past the fewest hazardous places, and the other route type is “shortest distance”, giving preference to the route of the shortest distance to the intended destination.

The Unsafe Location destination type has only one route strategy, which is the “shortest distance” strategy. If someone wants to find an unsafe location, the “hazard avoidance” strategy does not make sense as the Unsafe Location destination is a hazard itself.

So with 5 destination types each having two route strategies, and 1 destination having only one route strategy, that makes 11 route types that can be selected in this embodiment.

Routes Generation Algorithm:

Each network node is equipped with at least one sensor for detecting some type of disaster. When an emergency is detected, the network node detecting the disaster will do self-judgment and transmit the information of destination to its neighbor network nodes. When a network node receives the information of destination, it will also do a self-judgment and transmit the information of destination selectively to its neighbors.

The following is an explanation of how the route generation algorithm works when an emergency situation is detected:

### TERMINOLOGY EXPLANATION

Global Disaster Label: Each Network Node has a variable inside called “Global Disaster Label” to represent that whether any network node in the system detects emergency.

Total Disaster level: The number of hazardous places that a user needs to pass from current network node to the best network node which is a “destination.”

Total Distance: The walking distance from current network node to the best network node which is a “destination”.

Best neighbor: The neighbor device node which is nearest to the best network node which is a “destination”.

### Case 1: Initial Network Node, Global Disaster Label Set to False, Detects Emergency

Network node detects an emergency situation, such as a fire.

If the detecting network node is a “destination”:
Set Global Disaster Label to TRUE
Send the following information to all Neighbor nodes
   [Access to the destination at this Node]
   [Total Distance: Distance between this Node and the neighbor who will receive the info]
   [Total Disaster level: disaster situation at this Node (When emergency is detected at this area, disaster situation will be 1, otherwise, it will be 0)]

Else (if detecting node is NOT a “destination”):
Set Global Disaster Label to TRUE
Send the following information to all Neighbor nodes
   [No destination at this Node]
   [Total Distance: Distance between this Node and the neighbor who will receive the info]
   [Total Disaster level: disaster situation at this Node (When emergency is detected at this area, disaster situation will be 1, otherwise, it will be 0)]

### Case 2: Non-Initial Network Node, Global Disaster Label May be True or False

Receiving network node receives information from sending network node containing destination information.

If the information received is “Sending node has access to destination”

AND if receiving node is a “destination” AND Global Disaster Label of receiving node is FALSE:
Set Global Disaster Label to TRUE
Send the following information to sending neighbor node:
   [Access to the destination at this Node]
   [Total Distance: Distance between this Node and the neighbor who will receive the info]
   [Total Disaster level: disaster situation at this Node (When emergency is detected at this area, disaster situation will be 1, otherwise, it will be 0)]

Else If the information received is “Sending node has access to destination”

AND if receiving node is NOT a “destination” AND Global Disaster Label of receiving node is FALSE:
Set Global Disaster Label to TRUE
Treat sending Neighbor node as “Best Neighbor”
Send the following information to all Neighbor nodes:
   [Access to the destination at this Node]
   [Total Distance: Distance between this Node and the neighbor who will receive the info+Distance in the information received (Distance between the current node and the selected network node which is a “destination”)]
   [Total Disaster level: disaster situation at this Node+Disaster level in the information received (The sum of the disaster situation between sending Neighbor node and the selected network node which is a “destination”)]

Else If the information received is “Sending node has access to destination”

AND if receiving node is a “destination” AND Global Disaster Label of receiving node is TRUE:
Do nothing.

Else If the information received is “Sending node has access to destination”

AND if receiving node is NOT a “destination” AND Global Disaster Label of receiving node is TRUE and receiving node has a Best Neighbor:
If (Sending Node is the Best Neighbor)
   Firstly, send the following information to all Neighbor nodes:
      [No Destination at this Node]
   Secondly, send the following information to all Neighbor nodes:
      [Access to the destination at this Node]
      [Total Distance: Distance between this Node and the neighbor who will receive the info+Distance in the information received (Distance between the current node and the selected network node which is a “destination”)]
      [Total Disaster level: disaster situation at this Node+Disaster level in the information received (The sum of the disaster situation between sending Neighbor node and the selected network node which is a “destination”)]
If New Route is Better than Previous Route (Lower distance or disaster level)
   Treat Sending Node as Best Neighbor
   Send the following information to all Neighbor nodes:
      [Access to the destination at this Node]
      [Total Distance: Distance between this Node and the neighbor who will receive the info+Distance in the information received (Distance between the current node and the selected network node which is a “destination”)]
      [Total Disaster level: disaster situation at this Node+Disaster level in the information received (The sum of the disaster situation between sending Neighbor node and the selected network node which is a “destination”)]

Else If the information received is “Sending node has access to destination”

AND if receiving node is NOT a “destination” AND Global Disaster Label of receiving node is TRUE and receiving node DOES NOT have a Best Neighbor:
Treat Sending Node as Best Neighbor
Send the following information to all Neighbor nodes:
   [Access to the destination at this Node]
   [Total Distance: Distance between this Node and the neighbor who will receive the info+Distance in the information received (Distance between the current node and the selected network node which is a “destination”)]
   [Total Disaster level: disaster situation at this Node+Disaster level in the information received (The sum of the disaster situation between sending Neighbor node and the selected network node which is a “destination”)]

Else If the information received is “Sending node has NO access to destination”

AND if receiving node is a “destination” AND Global Disaster Label of receiving node is FALSE:
Set Global Disaster Label to TRUE
Send the following information to sending neighbor node:
   [Access to the destination at this Node]
   [Total Distance: Distance between this Node and the neighbor who will receive the info]
   [Total Disaster level: disaster situation at this Node. (When emergency is detected at this area, disaster situation will be 1, otherwise, it will be 0)]

Else If the information received is “Sending node has NO access to destination”

AND if receiving node is NOT a “destination” AND Global Disaster Label of receiving node is FALSE:
Set Global Disaster Label to TRUE
Send the following information to the Sending Node:
   [No Destination Exists at this Node]

Else If the information received is “Sending node has NO access to destination”

AND if receiving node is a “destination” AND Global Disaster Label of receiving node is TRUE:
Send the following information to the Sending Node:
   [Access to the Destination at this Node]
   [Total Distance: Distance between this Node and the neighbor who will receive the info]
   [Total Disaster level: disaster situation at this Node. (When emergency is detected at this area, disaster situation will be 1, otherwise, it will be 0)]

Else If the information received is “Sending node has NO access to destination”

AND if receiving node is NOT a “destination” AND Global Disaster Label of receiving node is TRUE and receiving node has a Best Neighbor:
If (Sending Node is the Best Neighbor)
   Send the following information to all Neighbor nodes:
      [No Destination at this Node]
Else
   Send the following information to the Sending node:
      [Access to the destination at this Node]
      [Total Distance: Distance between this Node and the neighbor who will receive the info+Distance in the information received (Distance between the current node and the selected network node which is a “destination”)]
      [Total Disaster level: disaster situation at this Node+Disaster level in the information received (The sum of the disaster situation between sending Neighbor node and the selected network node which is a “destination”)]

Else If the information received is “Sending node has NO access to destination”

AND if receiving node is NOT a “destination” AND Global Disaster Label of receiving node is TRUE and receiving node DOES NOT have a Best Neighbor:
Do nothing.

### Case 3: Non-Initial Network Node Detects Change of Disaster, Global Disaster Label is True

When a non-initial network node detects the change of disaster (the Global Disaster Label is TRUE), it will recalculate the route and send the information to its Neighbor Nodes as follows.

If the Receiving node is a “Destination”
Send the following information to all Neighbor nodes:
   [Access to the destination at this Node]
   [Total Distance: Distance between this Node and the neighbor who will receive the info]
   [Total Disaster level: disaster situation at this Node. (When emergency is detected at this area, disaster situation will be 1, otherwise, it will be 0)]

Else If the Receiving node is NOT a “Destination” but has a Best Neighbor:
Send the following information to all Neighbor nodes:
   [Access to the destination at this Node]
   [Total Distance: Distance between this Node and the neighbor who will receive the info+Distance in the information received (Distance between the current node and the selected network node which is a “destination”)]
   [Total Disaster level: disaster situation at this Node+Disaster level in the information received (The sum of the disaster situation between sending Neighbor node and the selected network node which is a “destination”)]

Else
Do nothing.

### Case 4: Network Node's Destination Status Changes

When network node's own destination status changes, it will recalculate the route and send the information to its Neighbor Nodes as follows:

If the Network node becomes a “Destination”
Send the following information to all Neighbor nodes:
   [Access to the destination at this Node]
   [Total Distance: Distance between this Node and the neighbor who will receive the info]
   [Total Disaster level: disaster situation at this Node. (When emergency is detected at this area, disaster situation will be 1, otherwise, it will be 0)]

Else If the Network node is no longer a “Destination”
Send the following information to all Neighbor nodes:
   [No destination exists at this Node]

### Case 5: Network Node is Destroyed or Recovered

When a network node is destroyed, its neighbor will detect this and do self-judgment. If the Global Disaster Label of the destroyed network node's neighbor is TRUE and the network node which is destroyed is its best neighbor, then it will send [No Destination Exists] to all other neighbor nodes.
When a network node is recovered, its neighbor will detect this and do self-judgment. If its Global Disaster Label is TRUE, then it will send information of its current destination to the network node which is recovered.

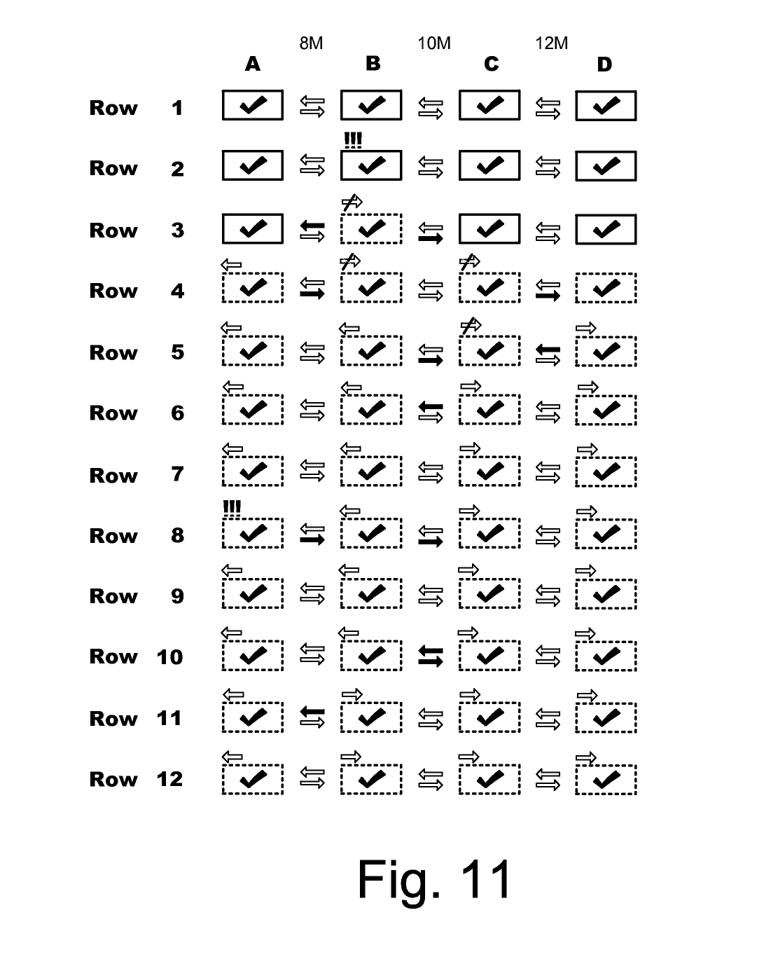

FIG. 11 is an illustration of how route generation can occur in one embodiment of the system of the present invention. In FIG. 11, the Nodes labeled A and D are associated with exists, and Nodes B and C are not.

Each numbered row in FIG. 11 represents a snapshot in time of the network, with Row 2 occurring later than Row 1, Row 3 occurring later than Row 2, and so on.

Row 1: Each device node (A, B, C, D) is working properly. The physical distances between nodes is:
AB distance: 8 meters
BC distance: 10 meters
CD distance: 20 meters

Row 2: Node B detects the emergency.

Row 3: Node B begins to do self-judgment, because it is an initial device node (Global disaster label is false), and it is not related to an exit, so it sends the information of destination [no destination exists] to its neighbors A and C, and sets its global disaster label to TRUE.

Row 4: Node A receives information from Node B, because Node A is related to the exit, it sends the information of destination [access to the destination], [total distance: distance between itself and neighbor B where information is sent to (8 m)], and [own disaster situation: 0] to its neighbor node B. Finally, it sets its global disaster label to TRUE.

Node C receives information from Node B, because C is not related to an exit, it sends the information of destination [no destination exists] to its neighbor B. Finally, it sets its global disaster label to TRUE.

Row 5: Node B receives information from Node A, since Node B does not have best neighbor, B treats A as its best neighbor, and send the information of destination [access to the destination], [distance: distance between itself and the neighbor C where information is sent to (10 M)+the distance information that it receives from its best neighbor A (8 M)=18 M], and [own disaster situation: 1+disaster level it receives form its best neighbor: 0=1] to other neighbors (C, in this case).

Node D receives information from Node C, because D is related to the exit, it sends the information of destination [access to the destination], [distance: distance between itself and neighbor C where information is sent to (20 m)], and [own disaster situation: 0] to its neighbor C. Finally, it sets its global disaster label to TRUE.

Row 6: Node C receives information from Node D, since C does not have best neighbor, C treats Node D as its best neighbor, and sends the information of destination [access to the destination], [distance: distance between itself and the neighbor B where information is sent to (10 M)+the distance information that it receives from its best neighbor D (20 M)=30 M], and [own disaster situation: 1+disaster level it receives form its best neighbor: 0=1] to other neighbors (Node B).

Node C receives information from Node B, and, since this route is not better than the previous one, C ignores this information.

Row 7: Node B receives information from Node C, and since this route is not better than the previous one, B ignores this information.

Row 8: Node A detects disaster, it sends the information of destination [access to the destination], [Total Distance: Distance between itself and neighbor B where information is sent to (8 m)], and [Total disaster level: own disaster situation which is equal to 1], to its neighbors (Node B).

Row 9: Node A receives information from Node B. Since A treats B as its best neighbor, it sends the information of destination [no destination exists] to other neighbors, C firstly.

Row 10: Then, Node B sends the information of destination [access to destination], [distance: distance it receives+the distance between itself and the neighbor C where information is sent to. (10 M)=18 M], and [own disaster situation: 1+received disaster level: 1=2] to other neighbors C.

Since C has a best neighbor which is not B, it sends the information of destination [access to the destination], [distance: distance it receives (20 M)+the distance between itself and the neighbor B where information is sent to (10 M)=30 M], and [own disaster situation: 0+received disaster level: 0=0] to Node B.

Row 11: Node B receives information from Node C, and since the new route is better than the previous one, B selects C as its best neighbor and send the information of destination [access to the destination], [distance: Distance it receives (30 M)+distance between itself and the neighbor A where information is sent (8 M)=38 M], and [own disaster situation: 1+received disaster level: 0=1] to Node A.

Row 12: Node A is related to exit, and its global disaster label is TRUE, so it ignores this information.

Receiving Routes Mechanism for Portable Electronic Devices:

When a user connects their portable electronic device to a network node, that network node will push routes information to that portable electronic device automatically.

When the network node updates any route, the node will push the new route information to all portable electronic devices connected to that node automatically, to ensure that users receive real time route information.

Set Destination Mechanism for Portable Electronic Devices:

The user can use a portable electronic device to change the destination status of any network node. (For example, I was trapped: Set “help”, or I'm a fireman: Set “rescue”).

Each node has two lists: one for saving the ID of portable electronic devices which change the setting to “help”, and another for saving the ID of portable electronic devices which change the setting to “rescue”.

When a user sends a help signal by using their portable electronic device, the node will save that user's portable electronic device ID in a list. If this node is already a help destination, do nothing, otherwise update the route, send the information of destination [access to the destination], [Total Distance: Distance between this Node and the neighbor who will receive the info] and [Total Disaster level: disaster situation at this Node. (When emergency is detected at this area, disaster situation will be 1, otherwise, it will be 0)] to all the neighbors.

When a user use their portable electronic device to cancel the help signal it sent before, or their portable electronic device is disconnected, the network node will remove the ID in the list. If the count of list content is 0, update the destination route, send the information of destination [no destination exists] to all the neighbors. Otherwise do nothing.

The list for saving ID is for handing this situation. When user A and B both send a help signal at the same time and are in the same area, the network node will update the destination status. If A leaves, and B is still here, the count of list is not 0, and the destination status does not change. Only when both A and B leave, and the count of list is 0, will the destination status change.

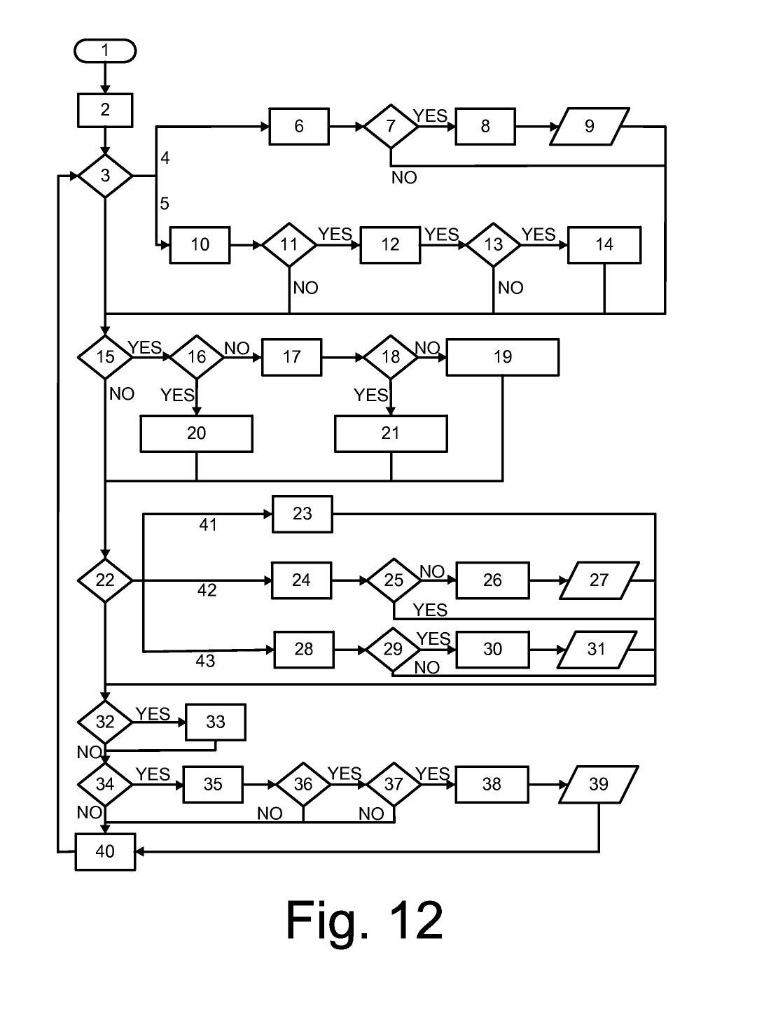

FIG. 12 is a flowchart capturing one embodiment of an algorithm that may be used with the system of the present invention. The functions of the flowchart are explained in the following text, using the numbers given on the flowchart shapes.
1. Start.
2. Initialization.
3. Information from neighbor network nodes.
4. The information of destination.
5. Periodic information.
6. Update the corresponding routes and the global disaster label depending on the type of the information of the destination.
7. Route is changed,
8. [1] Inform other neighbors, [2] Inform all the users' portable electronic devices.
9. Change the status of loudspeaker and route indication device,
10. Reset counter for counting whether neighbors is timeout or not.
11. Any neighbor device node is recovered.
12. Inform the host computer.
13. Global disaster label is TRUE.
14. Send the current information of destination to this neighbor.
15. Sensor status changes.
16. Global disaster label is TRUE,
17. Set global disaster label to TRUE.
18. Is destination.
19. Send the information of destination [No destination exists] to all the neighbors.
20. Recalculate and send the information of destination to all the neighbors (except the best neighbor).
21 Send the information of destination [Access to destination], [Total distance] and [Total disaster level] to all the neighbors.
22. Any interaction from user s portable electron device.
23. Send the information of destination to users' portable electron device.
24. Add user's portable electron device ID to the list, if it does not exist in the list.
25. Current device was destination before users' interaction.
26. [1] Send the information of destination [access to destination], [Total distance] and [Total disaster level] to all the neighbors, [2] Inform all the users' portable electronic devices which connects to this device node.
27. Change the status of loudspeaker and route indication device.
28. Remove the user's portable electron device ID from the list, if it exists in the list.
29. The count of the list is 0.
30, [1] Send the information of destination [destination does not exist] to all the neighbors. [2] inform all the users' portable electronic devices which connects to this device node.
31. Change the status of loudspeaker and route indication device.
32. Information from the host computer.
33. Do corresponding action.
34. Any neighbor is timed out.
35. Inform the host computer that that neighbor is abnormal.
36. Global disaster label is TRUE.
37. That neighbor is the best neighbor.
38, [1] Send the information of destination [destination does not exist] to all the neighbors. [2] Inform all the portable electronic devices which connects to this network node.
39. Change the status of loudspeaker and route indication device.
40. Send collected data to the host computer (if is necessary).
41. New portable electronic device connects.
42. Set current device node as destination (help or rescue).
43. Portable electronic device disconnects, or cancels the previous setting of destination.

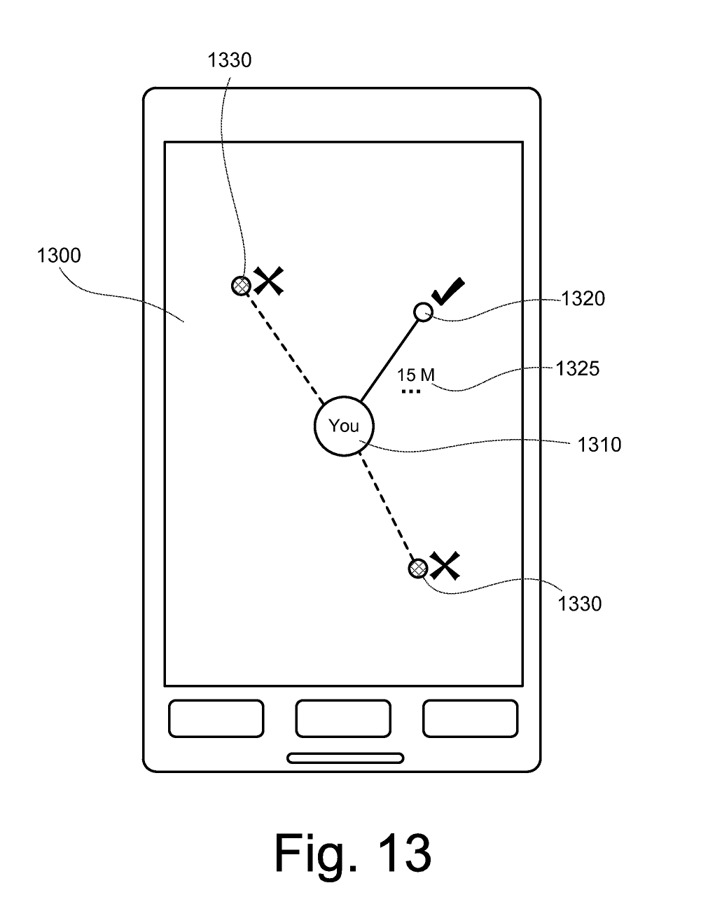

Users of this system can choose the route that they need to view from their portable electronic device. FIG. 13 is an illustration of one embodiment of a user device interface screen 1300 showing safe evacuation routes.

An icon representing the user 1310 is shown on the screen, with routes indicated with lines spreading out from the user icon 1310. Destinations that are not safe 1330 are marked with an “X” or otherwise shown to be undesirable. Destinations that are safe 1320 are shown with a checkmark or otherwise shown to be acceptable. Distance to destination 1325 and other information may be displayed next to routes.

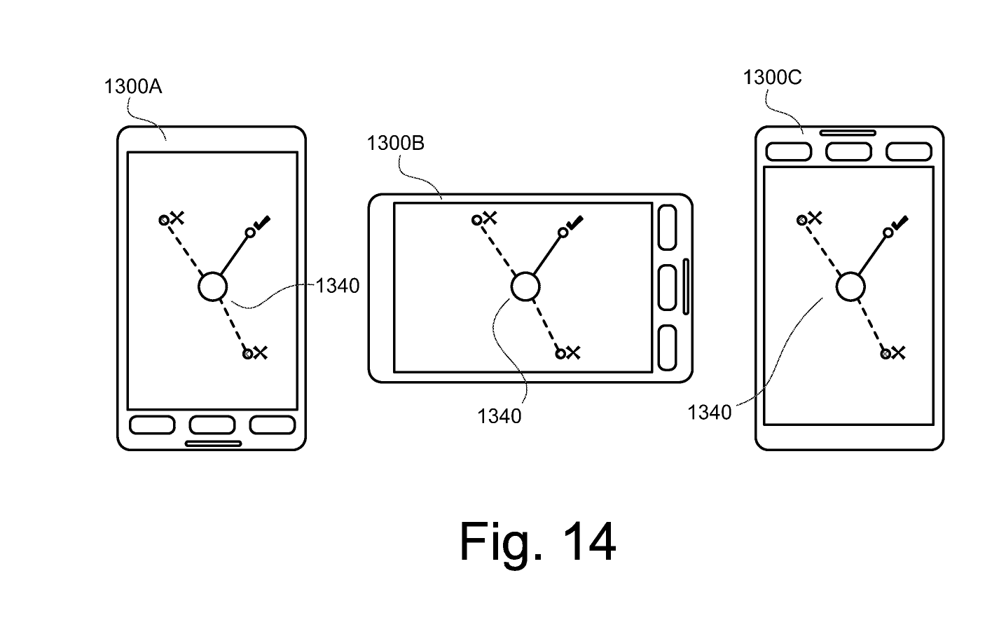

In the preferred embodiment, the application can adjust the direction of the interface by utilizing the internal orientation sensors in the portable electronic device. Regardless of how user rotates it portable electronic device, the application can correctly display the right corresponding direction. FIG. 14 is an illustration of how the orientation of the evacuation route screen of FIG. 13 can be changed such the directions indicated on the device match those in the real building. Orientation 1300A shows how the graphics 1340 indicate a safe node generally in the direction the device is pointing. In orientation 1300B, the user has turned 90 degrees from orientation 1300A, but the graphics 1340 have changed in relation to the device such that they are still pointing in the general direction of the safe node. If the user turns another 90 degrees as in orientation 1300C, the graphics 1340 again rotate in the opposite direction so they stay oriented true to the physical reality of the nodes.

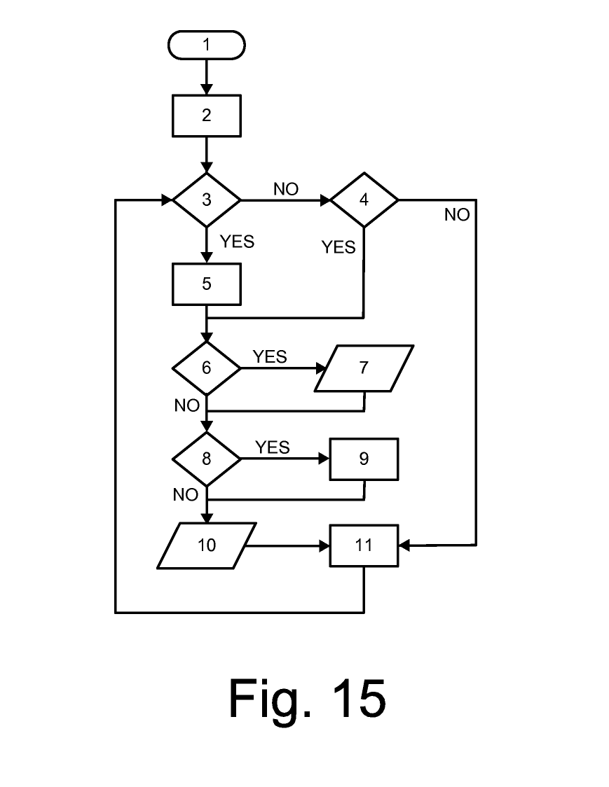

FIG. 15 shows a flowchart capturing one embodiment of an algorithm that may be executed on a portable device in the system of the present invention.

In general terms, the application on the device is constantly checking for a signal that it can detect, and will connect to the network node which has strongest signal automatically. When a new device is connected to the network node, the network node will automatically send data to the device, and the node will automatically push route updates data to the device, allowing users to get real-time valid data. When the portable electronic device does not detect any signal, it will automatically display a connection error message to the user. A portable electronic device can send both “help” and “rescue” signals, and can also cancel both types of signal.

The functions of the application flowchart of FIG. 15 are explained in the following text, using the numbers given on the flowchart shapes.
1. Start
2. Initialization
3. Better signal strength exists
4. Connecting to any device node
5. Swift connecting to that device node
6. Data from any node
7. Read Data from that node
8. Interaction data from users
9. Send interaction data to that device node
10. Read portable electronic device's direction situation
11. Update the interface

Use Case Examples:

There are some examples, that this solution can be used.

Outdoor Farms:

Install this solution in the farm, detecting the fire and insects or other pests.

The Smart Road:

Install this solution in the road. When a driver detects an abnormality in the road on which the car is traveling, they can inform the road, and the information will be shared with all cars which connect to the road.

Install this solution in the road. When a driver feels sleepy, their car can inform the road automatically, then all the cars which connects to the road can be notified when a tired driver is approaching.

Install this solution in the road. A driver can get a traffic report on any cars traveling on the road ahead or behind them.

Smart Market:

Install this solution in the marketplace. Not only can people get better service, but they can be informed when an emergency happens.

Smart Hotel:

Install this solution in the hotel. Not only can people easily find their ways out of danger, improving their probability of surviving an emergency.

Smart Location of Individuals:

Install this solution in the public area. Not only can people easily identify their location, but also it can improve the probability of surviving when emergency happens.

Smart Parking:

Install this solution in the parking area. Driver can easily locate an empty parking spot and find their car's location when they come back out of the shop.

Additional features and alternate embodiments are possible without deviating from the intent of the inventive concept described here.

What is claimed:

1. A flexible destination setting and route indication system, comprising:
a central computer;
a plurality of network nodes, wherein each network node comprises at least one sensor for detecting an environmental condition and a wireless communication module;
a computer program; and
application software,
wherein the plurality of network nodes form a wireless communications network with each other, wherein a subset of the plurality of network nodes are connected via a direct connection to the central computer; wherein the computer program executes on the central computer, wherein the computer program is used to configure the wireless communications network, wherein the central computer communicates configuration information via the hardwired connection to the subset of the plurality of network nodes, wherein the subset of the plurality of network nodes distributes the configuration information to all network nodes via the wireless communications network, wherein the at least one sensor in each network node in the wireless communications network is capable of detecting an emergency situation, wherein the presence of an emergency situation is communicated throughout the wireless communications network and used to generate route information for a user in the emergency situation, wherein the application is executing on a personal electronic device of the user in the emergency situation, and wherein the route information is communicated by the plurality of network nodes to the application so that route information is communicated to the user.

2. The flexible destination setting and route indication system of claim 1, wherein the wireless communications network is an ad hoc communications network.

3. The flexible destination setting and route indication system of claim 1, wherein the at least one sensor is selected from the group consisting of fire alarm, smoke alarm, temperature sensor, earthquake sensor, environmental sensor, motion detector, plant disease detector, and proximity sensor.

4. The flexible destination setting and route indication system of claim 1, wherein the central computer is not required for operation of the flexible destination setting and route indication system once configuration information has been sent to the subset of the plurality of network nodes.

5. The flexible destination setting and route indication system of claim 1, wherein the direct connection is a hardwired connection.

6. The flexible destination setting and route indication system of claim 1, wherein the direct connection is a wireless connection.
